(19) United States
(12) Patent Application Publication
(10) Pub. No.: US 2012/0023260 A1
(43) Pub. Date: Jan. 26, 2012

(54) DIAGONALLY ENHANCED CONCENTRATED HYPERCUBE TOPOLOGY

(75) Inventor: Cyriel Minkenberg, Rueschlikon (CH)

(73) Assignee: INTERNATIONAL BUSINESS MACHINES CORPORATION, Armonk, NY (US)

(21) Appl. No.: 13/186,096

(22) Filed: Jul. 19, 2011

(30) Foreign Application Priority Data
Jul. 26, 2010 (EP) 10170813.9

(51) Int. Cl. G06F 15/16

(52) U.S. Cl. 709/238

(57) ABSTRACT

The invention is directed to a system comprising routing nodes, computing nodes, first communication links, wherein the first communication links connect pairs consisting of two routing nodes together, the routing nodes and the first communication links forming a hypercube structure, second communication links, wherein the second communication links connect pairs consisting of a routing node and a computing node together, third communication links, wherein the third communication links connect pairs consisting of two routing nodes together.

### FIELD OF THE INVENTION

The invention relates to the field of computer science, and specifically to computer networking

### BACKGROUND

Interconnection networks for parallel computers come in various forms. In general, a parallel computer system comprises computing nodes (also known as “end” nodes or “processor” nodes) and routing nodes (also known as “routers” or “switches”).

A basic distinction is made between direct networks, in which each routing node is connected to one or more computing nodes, and indirect networks, in which computing nodes are connected to a subset of the routing nodes, such that the routing nodes can be separated into two groups: the edge routing nodes which connect to the computing nodes, and the internal routing nodes, which connect only to other routing nodes.

The most common indirect topologies are the banyan (k-ary d-fly) and the fat tree (also known as k-ary d-tree); the most common direct topologies are the mesh (k-ary d-mesh), and the torus (k-ary d-cube), where k is the arity and d the number of dimensions. A binary d-mesh is usually referred to as hypercube. In a hypercube, there are n=2̂d computing nodes and 2̂d routing nodes, each computing node connected to one routing node, and each routing node connected to d other routing nodes along d different dimensions.

The bisection bandwidth of a network is the sum of bandwidths of all links that need to be removed in order to divide the network into two equal parts. A high bisection bandwidth is generally a desirable property for a network. A network is said to offer a full bisection bandwidth when the sum of bandwidths of all links connecting the computing nodes to the network is equal to the bisection bandwidth, which is a desirable property.

Fat trees offer full bisection bandwidth, at the price of requiring either a high switch radix (i.e. the number of links connected to a routing node) or a large number of tree levels. Meshes and tori generally require low switch radii, at the price of having a large network diameter (large maximum hop count between nodes) and offering a small bisection bandwidth.

An advantage of hypercubes is their high dimensionality: in a d-dimensional hypercube, each routing node is directly connected to d other routing nodes. Moreover, due to its specific interconnection pattern, the node numbers of the neighbors of a given node are at a distance of 1, 2, 4, 8, etc, i.e., in a binary representation, the node numbers of neighboring nodes differ in exactly one bit. This property is highly beneficial for many communication patterns encountered in parallel applications. In particular, many of the most commonly used collective operations used in message passing as well as shared memory programming models are often implemented using so-called distance doubling or distance halving algorithms, which give rise to a binomial tree communication pattern, which in turn maps perfectly onto a hypercube topology, in the sense that all communications occur between directly neighboring routing nodes only. Examples of such collective operations are “gather”, “scatter”, “reductions” (sum, min, max, product, etc), “all_gather”, “all_scatter”, “all-to-all”, etc. An example of an important computational kernel that uses a global reduction is the Fast Fourier Transform (FFT).

Hypercubes offer full bisectional bandwidth, just like fat trees. Unfortunately, hypercubes do not scale very well to support a large number of nodes, because the network diameter scales linearly with the number of dimensions. Moreover, the ratio between the number of network links to the number of end nodes increases linearly with the number of dimensions d (i.e., with log_{—}2(n)), and the total number of routing nodes equals the number of end nodes n. Hypercubes serve as a basis for the networks disclosed in U.S. Pat. No. 5,170,482.

To address this issue, one can turn to concentrated hypercubes, in which multiple, say k, computing nodes are connected to each routing node, leading to a topology supporting k*2̂d computing nodes using 2̂d routing nodes. To balance the incoming and outgoing bandwidth per routing node, k is generally lower than or equal to d, so that the maximum number of end nodes in a concentrated hypercube is achieved when k equals d. To support the same number of end nodes, a concentrated hypercube requires fewer dimensions than a regular hypercube; this ratio can be shown to be equal to W(d*ln(2))/ln(d), where W is the Lambert W function (product-log). In addition, unlike in a hypercube, in a concentrated hypercube the ratio of the number of network links to the number of end nodes is constant, independent of d, and the ratio between the number of routing nodes and the number of end nodes is 1/d, which is also a factor of d better. On the downside, the bisectional bandwidth of a concentrated hypercube equals 1/d, so it decreases with the number of dimensions.

Furthermore, in a concentrated hypercube, despite d links being available to route traffic from the d computing nodes attached to a given routing node, it can be shown that link conflicts will arise for the typical binomial-tree communication patterns outlined above.

A topology related to the concentrated hypercube is the so-called cube-connected cycles (CCC) topology. This topology is discussed by Preparata, Franco P.; Vuillemin, Jean, in “The cube-connected cycles: a versatile network for parallel computation”, 1981, Communications of the ACM 24 (5): 300-309. A d-dimensional CCC also supports d*2̂d end nodes, arranged in a d-dimensional hypercube, where each hypercube node is made up of a ring of d nodes. The advantage of a CCC is that the degree of each node is constant, independently of the number of dimensions. However, the bisection bandwidth is lower than that of a hypercube. Compared to a concentrated hypercube, the diameter is larger.

One goal of the present invention addresses is thus to provide an improved network topology.

### BRIEF SUMMARY OF THE INVENTION

According to one aspect, the invention is embodied as a system comprising routing nodes, computing nodes, first communication links, wherein the first communication links connect pairs consisting of two routing nodes together, the routing nodes and the first communication links forming a hypercube structure, second communication links, wherein the second communication links connect pairs consisting of a routing node and a computing node together, third communication links, wherein the third communication links connect pairs consisting of two routing nodes together.

In embodiments, the system may comprise one or more of the following features:
the routing nodes, the computing nodes, the first communication links and the second communication links form a concentrated hypercube network;
the number of computing nodes connected to a routing node is equal to the number of dimensions of the hypercube structure;
the third communication links connect pairs consisting of two routing nodes which are not connected by a first communication link;
the third communication links correspond to diagonals of the hypercube structure;
each of the third communication links corresponds to a respective one of the diagonals, the number of third communication links being the same as the number of diagonals;
within at least one routing node, at least some of the crosspoints are not implemented;
the crosspoints which are not implemented are crosspoints from one third communication link to another third communication link, from a second communication link to a third communication link, and/or from a third communication link to a first communication link.

According to another aspect, the invention is embodied as a method for circulating information over the system of any of claims 1 to 8, the method comprising transmitting information between at least one first computing node and at least one second computing node, via at least one third communication link.

In embodiments, the method comprises one or more of the following features:
the at least one first computing node is connected to a first routing node, and the at least one second computing node is connected to a second routing node, the first and second routing nodes are connected together, the transmitting of the information is via at least one first communication link, the at least one first communication link and the at least one third communication link connecting the first and second routing nodes to at least one third routing node, the method further comprises, at least partly simultaneously to the transmitting of the information, the transmitting of other information between a third computing node connected to the first routing node and a fourth computing node connected to the second routing node via a first communication link connecting the first and second routing nodes together;
the at least one first computing node consists of all the computing nodes connected to the first routing node distinct from the third computing node, and the at least one second computing node consists of all the computing nodes connected to the second routing node distinct from the fourth computing node fourth;
the transmitting of the information and the transmitting of the other information are iterated over all pairs of routing nodes of the system which are connected together.
According to another aspect, the invention is embodied as a computer program comprising instructions for causing a routing node belonging to the above system to perform the above method.
According to another aspect, the invention is embodied as a computer program comprising instructions for causing a computing node belonging to the above system to perform the above method.

### BRIEF DESCRIPTION OF THE DRAWINGS

A system and a process embodying the invention will now be described, by way of non-limiting example, and in reference to the accompanying drawings, where:

FIG. 1 is a block diagram of hardware of a computing node;

FIG. 2-FIG. 4 show hypercubes;

FIG. 5 and FIG. 6 show diagrams representing examples of a particular system;

FIGS. 7-9 show the circulation of information on a system according to FIG. 5;

FIGS. 10-14 show characteristics of the system compared to other systems.

### DETAILED DESCRIPTION OF THE EMBODIMENTS

A system is proposed comprising routing nodes and computing nodes. The system comprises first communication links. The first communication links connect pairs consisting of two routing nodes together. The routing nodes and the first communication links form a hypercube structure. The system comprises second communication links. The second communication links connect pairs consisting of a routing node and a computing node together. The system comprises third communication links. The third communication links connect pairs consisting of two routing nodes together. Such a system offers the advantages of networks wherein the routing nodes form a hypercube structure while increasing the bisection bandwidth and decreasing conflicts when the computing nodes communicate with each other.

The expression “communication link” designates any means for circulating information between two nodes to which the communication link connects. A communication link may comprise a wire, e.g. an optical fiber. Alternatively, a communication link may simply designate any means to allow two nodes to communicate together wirelessly, for example storing of their respective identifiers. A communication link is preferably bidirectional. A bidirectional communication link allows for the simultaneous exchange of information in both directions.

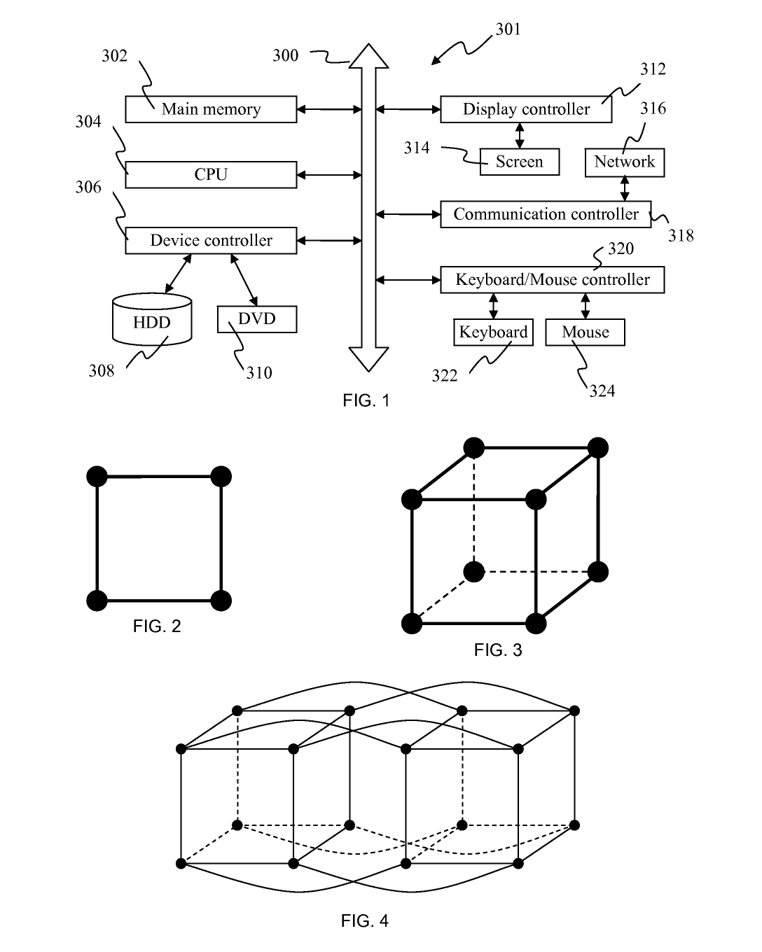

The expression “computing node” designates any means for processing information. A computing node may comprise a computer, e.g. a desktop or a laptop computer. FIG. 1 is a block diagram of hardware of a computing node according to an example of the invention. The computing node (301) according to the example includes a CPU (304) and a main memory (302), which are connected to a bus (300). The bus (300) is connected to a display controller (312) which is connected to a display (314) such as an LCD monitor. The display (314) is used to display information about a computer system. The bus (300) is also connected to a storage device such as a hard disk (308) or DVD (310) through a device controller (306) such as an IDE or SATA controller. The bus (300) is further connected to a keyboard (322) and a mouse (324) through a keyboard/mouse controller (320) or a USB controller (not shown). The bus is also connected to a communication controller (318) conforms to, for example, an Ethernet protocol. The communication controller (318) is used to physically connect the computer system (301) with a network (316). A computing node may also more simply consist of a processor (e.g. the CPU (304) of FIG. 1). At a lower level, a computing node may consist of a transistor.

The expression “routing node” designates any means for receiving and emitting information through communication links which connect to a routing node. Often referred to as a router, a routing node may be wired to the network or wireless.

The system having communication links between routing nodes and computing nodes, the system constitutes a communications network, possibly between processors if the computing nodes are processors. A communications network notably allows parallel computing. In a physical network, a computer may function both as a computing node and as a routing node. In that case, the computer may be viewed as a computing node and a routing node, with a link between them.

The system comprises at least three categories of links: the first, second and third communication links. The second communication links are links which connect a routing node with a computing node. The first and third communication links are links which connect two routing nodes together. It is to be understood that the third communication links are distinct from the first communication links. Physically, the first and third communication links are generally similar, although they can alternatively be of different constitution. The first and third communication links differ mainly in their function within the system. Indeed, the routing nodes and the first communication links form a hypercube structure. In other words, if one considers a hypercube, the first communication links correspond to respective edges of the hypercube, while the routing nodes correspond to respective vertices. Hypercubes are known per se from geometry. In geometry, a hypercube is an n-dimensional analogue of a square (n=2) and a cube (n=3). FIG. 2 to FIG. 4 represent the hypercubes of dimension respectively equal to 2, 3 and 4. The third communication links are thus other communication links which connect pairs consisting of routing nodes.

The system thus provides the same advantages of network topologies wherein the routing nodes form a hypercube structure, e.g. the hypercube network, or the concentrated hypercube network. For instance, the system allows conflict-free binomial tree communication patterns. The system also offers full bisection bandwidth. And because the system comprises additional links between the routing nodes, namely the third communication links, the system has an increased bisection bandwidth, notably compared to a concentrated hypercube topology. For the same reason, the system also decreases conflicts when the computing nodes communicate with each other.

The routing nodes, the computing nodes, the first communication links and the second communication links may form a concentrated hypercube network. In other words, multiple computing nodes may be connected to each routing node by second communication links. Such a network may thus support a large number of nodes. The number of computing nodes connected to one single routing node is preferably lower than or equal to the dimension d of the hypercube structure. This balances the incoming and outgoing bandwidth per routing node. The number of computing nodes connected to a routing node may actually be equal to the dimension d of the hypercube structure. This achieves the maximum number of computing nodes for a given dimension, while keeping balance between the incoming and outgoing bandwidth per routing node. More generally, per routing node, the aggregate second link bandwidth should not exceed the aggregate first link bandwidth.

The third communication links may connect pairs consisting of two routing nodes which are not connected by a first communication link. The third communication links thus create new paths from one routing node to another. This allows reducing the mean of the number of hops when using the system, wherein a hop is the transmission of information (e.g. a packet of data) over a communication link between two routing nodes. More specifically, the third communication links may correspond to diagonals of the hypercube structure. This basically means that the third communication links connect two routing nodes which correspond to respective vertices of the hypercube, the said vertices belonging to a same face of the hypercube but not to the same edge. If such a third communication link connects to a given routing node, the given routing node may transmit information to the other routing nodes of the face which supports the diagonal with at least two or three paths, depending on the implemented crosspoints, as will be explained later, and a maximum number of hops equal to 2. This allows conflict management.

Each of the third communication links may correspond to a respective one of the diagonals, the number of third communication links being the same as the number of diagonals. In other words, for each diagonal of the hypercube, there is one third communication link. This allows an optimal use of the hypercube structure for conflict management.

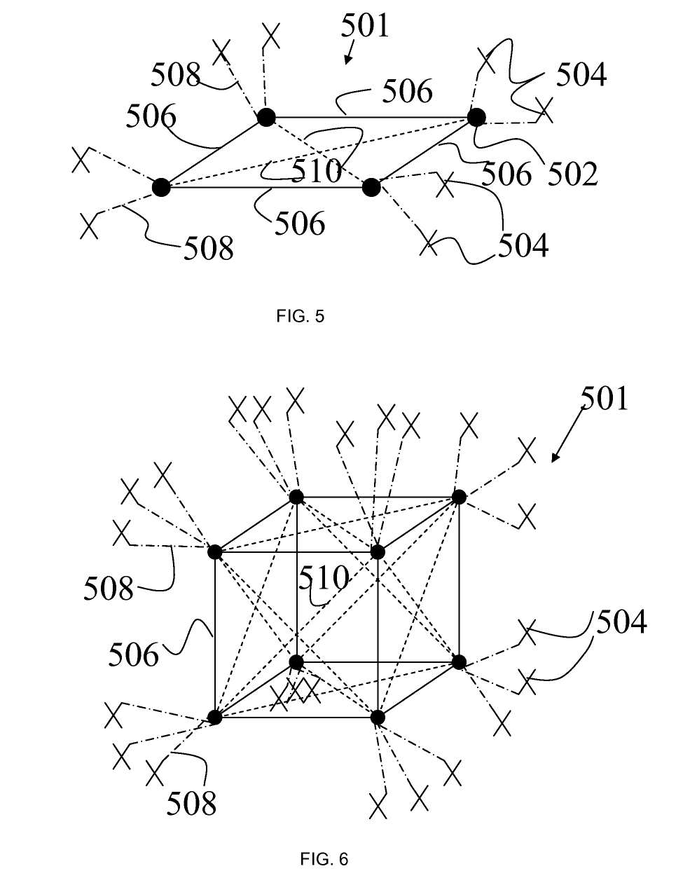

FIG. 5 and FIG. 6 show diagrams representing examples of a particular system wherein the dimension is respectively equal to 2 and 3. Referring to the examples of FIG. 5 and FIG. 6, the system 501 comprises routing nodes 502, represented by circles, computing nodes 504, represented by crosses, the number of computing nodes 504 per routing node 502 being equal to the dimension. The system 501 also comprises first communication links 506 which connect pairs consisting of two routing nodes 502 together, represented by full lines. As can be seen, the routing nodes 502 and the first communication links 506 form a hypercube structure. This corresponds to a square in dimension 2, as represented on FIG. 5, and to a cube in dimension 3, as represented on FIG. 6. The system 501 also comprises second communication links 508 which connect pairs consisting of a routing node 502 and a computing node 504 together, represented by chain dotted lines. The system also comprises third communication links 510, represented by dotted lines, which correspond to each of the diagonals of the hypercube structure. The example of FIG. 5 and FIG. 6 can be generalized to higher dimensions d. As can be verified on the figures, by construction a system wherein the dimension is equal to d comprises 2̂d routing nodes 502, and by definition of a concentrated hypercube network where k=d, d*2̂d computing nodes (d computing nodes connected to each routing node).

The system discussed above may be used as a network to circulate information, possibly for parallel computing. In general, a method for circulating information over the system comprises transmitting information via at least one third communication link. In other words, the path taken by the information comprises at least one third communication link. The third communication link thus serves its purpose of reducing the load of the communication links forming the hypercube topology, i.e., the first communication links.

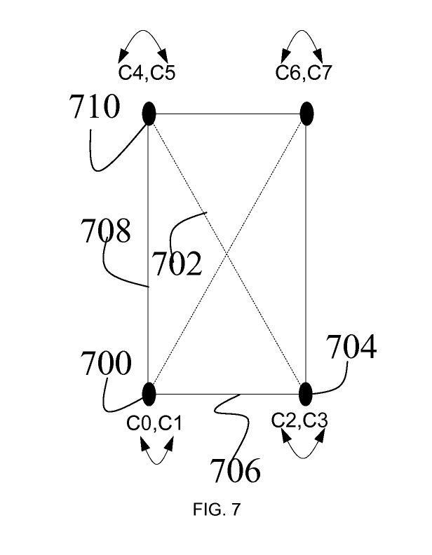

Particular examples of the method will now be discussed with reference to FIG. 7-9, which represent by arrows the circulation of information on a system according to FIG. 5 (i.e. wherein notably the dimension is equal to 2). On FIG. 7-9, the eight computing nodes are each represented by the symbol “Ci”, where i is any integer from 0 to 7. The second communication links 508 of FIG. 5 are not represented for the sake of clarity, but each computing node is indeed connected to a routing node by a second communication link.

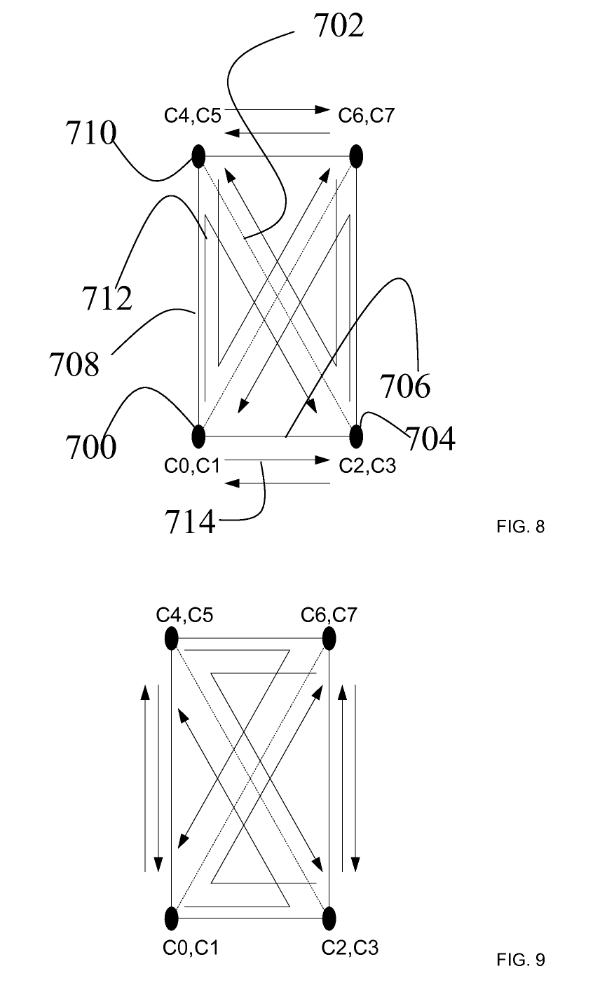

The method may comprise the transmitting of information between at least one first computing node, for example node C1, and at least one second computing node, for example node C3, via at least one third communication link 702. The at least one first computing node C1 may be connected to a first routing node 700, and the at least one second computing node C3 may be connected to a second routing node 704. The first 700 and second 704 routing nodes may be connected together (by a first communication link 706). The transmitting of the information may also be via at least one first communication link 708, the at least one first communication link 708 and the at least one third communication link 702 connecting the first 700 and second 704 routing nodes to at least one third routing node 710. In other words, the information circulates between two routing nodes via a third routing node, with two hops, thanks to the diagonal communication link. This transmission of information between C1 and C3 is represented by arrow 712 in FIG. 8. The method may further comprise, at least partly simultaneously to the transmitting of the information, the transmitting of other information between a third computing node C0 connected to the first routing node 700 and a fourth computing node C2 connected to the second routing node 704 via a first communication link 706 connecting the first 700 and second 704 routing nodes together. The transmission of the other information is thus direct, with only one hop, using the edge which connects the two routing nodes. The transmission of the other information is represented by arrow 714 on FIG. 8. The third communication link 702 thus allows all computing nodes C0 and C1 connected to the first routing node 700 to communicate with the computing nodes C2 and C3 connected to the second routing node 704 simultaneously without sharing any communication link, so that each communication can utilize the full link bandwidth. This offers a way to manage conflicts.

As shown on FIG. 7-9, with a hypercube of dimension 2, there is only one first computing node for the first routing node, namely C1 in the example, and only one second routing node, namely C3 in the example (C0 and C1 could be inversed in their role, and the same is true for C2 and C3).

However, in the more general case, the at least one first computing node consist of all the computing nodes connected to the first routing node distinct from the third computing node, and the at least one second computing node consist of all the computing nodes connected to the second routing node distinct from the fourth computing node fourth. More simply, the idea is to transmit information from each of the computing nodes connected to a first routing node to each of the computing nodes connected to a second routing node. One of the computing nodes connected to the first routing node, namely the third computing node, transmits information, namely the “other” information, to one of the computing nodes connected to the second routing node, namely the fourth computing node, directly via the first communication link which connects the two routing nodes. This link being thus used, the computing nodes connected to the first routing node distinct from the third computing node (the first computing nodes) have to take other paths to transmit their information to the computing nodes connected to the second routing node distinct from the fourth computing node (the second computing nodes), if they want to transmit their information at least partly simultaneously without conflicts. A solution is thus to follow a two-hops path using the diagonal third communication links. One way to do that consists, for each first computing node, to transmit information via one respective third routing node connected with the first routing node by a first communication link and connected to the second routing node by a third communication link. If the system corresponds to a concentrated hypercube network with third communication links on all diagonals, then it is ensured that all first computing node may send their information simultaneously this way, provided that the number of computing nodes per routing nodes is equal or inferior to the dimension. Indeed, for each first computing node, there is one edge connecting to the first routing node.

Referring back to FIG. 7-9, a method for circulating information such that all computing nodes acquire the information from all other computing nodes of a system according to the example of FIG. 5 is described. Because it is exhaustive, such a method is of course also convenient if less information needs to be transmitted.

FIG. 7 shows a first phase of such a method. In this first phase, the computing nodes connected to a same routing node exchange their information via the second communication links which connect them to the routing node. The pairs (C0 and C1), (C2 and C3), (C4 and C5), and (C6 and C7) thus exchange information within a pair independently and simultaneously without conflicts.

FIG. 8 shows a second phase of the method. In this second phase, a pair of computing nodes connected to a first routing node exchanges information with a pair connect to second routing node, the first and second routing nodes being connected together (by a first communication link). This is performed as described above, i.e. by using indirect paths involving third communication links in order to avoid conflicts and perform simultaneous transmissions, represented by the arrows. For example, C0 and C2 exchange their information via first communication link 706 while C1 and C3 exchange their information via first communication link 708 and third communication link 702. It is worthwhile to notice that before the second step, each of the computing nodes not only possesses information that it initially possessed, but also information acquired during the previous phase. Consequently, at the end of this second phase, each of the nodes C0, C1, C2, C3 possesses the same information, which is the sum of information initially possessed by each of nodes C0, C1, C2, C3. During the second phase, C4, C5, C6, C7 operate the same way as C0, C1, C2, C3, simultaneously, without conflicts.

Basically, the transmitting of the information and the transmitting of the other information are iterated over all pairs of routing nodes of the system which are connected together. This is represented by FIG. 9 which shows a third phase, where the computing nodes C0 and C1 exchange with the computing nodes C4 and C5, while simultaneously the computing nodes C2 and C3 exchange with the computing nodes C6 and C7. At the end of this third phase, each of the computing nodes possesses the information initially possessed by all the other computing nodes.

With d dimensions, the same may be performed in a number of phases equal to log(d)+d. Indeed, the phase of FIG. 7, which corresponds to the exchange of information between computing nodes connected to a same routing node, may be performed in a number of steps equal to log(d) (the ceiling may be taken if log(d) is a non integer). Then, the method may comprise one phase for each dimension, so that there are d more phases.

Within at least one routing node of the system, at least some of the crosspoints may be not implemented. A crosspoint is a means to connect, within a routing node, between two links connecting to a routing node. Thus, if node N1 is connected to a routing node by link L1 and node N2 is connected to the same routing node by link L2, then N1 may transmit information to N2 if the crosspoint from link L1 to link L2 is implemented. The crosspoint complexity of a system is a measure of the total number of crosspoints that are implemented within all the routing nodes of the system. Not implementing some crosspoints decreases the crosspoint complexity.

The crosspoints which are not implemented may be crosspoints from one third communication link to another third communication link, from a second communication link to a third communication link, and/or from a third communication link to a first communication link. Such a system allows minimal implementation of crosspoints while allowing conflict-free communication. Indeed, the method for circulating information described with reference to FIG. 7-9 does not need these crosspoints to be implemented in order to be applied. Of course, if other methods for circulating information are to be executed on the system, the unimplemented crosspoints might be different. For instance, in the second and third phases as described above, information is sent by following an edge and then a diagonal of the hypercube structure. Conversely, the information could follow a diagonal and then an edge of the hypercube structure. With such a method, the crosspoints from a first communication link to a third communication link may be unimplemented, whereas crosspoints from a third communication link to a first communication link would be implemented. Thus, in both cases, a conflict-free exchange of information from all nodes to all other nodes of such a system, with a maximum number of hops of two at each transmission, and with a reduced complexity (provided by the reduced number of implemented crosspoints), is provided.

The system and method presented above thus enable conflict-free routing of any binomial-tree communication pattern using at most two hops for any number of dimensions d. Compared with a d-dimensional hypercube network, the system of FIG. 5 and FIG. 6 generalized to higher dimensions has the same (i.e., full) bisection bandwidth, a 50% lower ratio of network-internal links to end nodes and a d times lower ratio of routing nodes to end nodes, so that, despite the per-switch radix being significantly higher, the overall complexity in terms of “crosspoint complexity” is roughly the same (taking into account that the crosspoint complexity can be reduced significantly by observing that many turns are never taken, as mentioned above).

For a given routing node, there are (d choose 2)=d*(d−1)/2 diagonals, so the radix of each routing node in the system equals d*(d+3)/2, including the links along the edges of the hypercube and the links to the end nodes. It can be shown that the ratio of network links to end nodes equals (d+1)/4, which is almost a factor of 2 better than in a regular hypercube. The ratio of routing nodes to end nodes equals 1/d (as in a concentrated hypercube), and the bisectional bandwidth ratio equals 1.

This topology takes advantage of the trend towards high-radix routing nodes to enhance connectivity, i.e., increase bisectional bandwidth, reduce network diameter, and enable contention-free routing of binomial-tree permutation patterns.

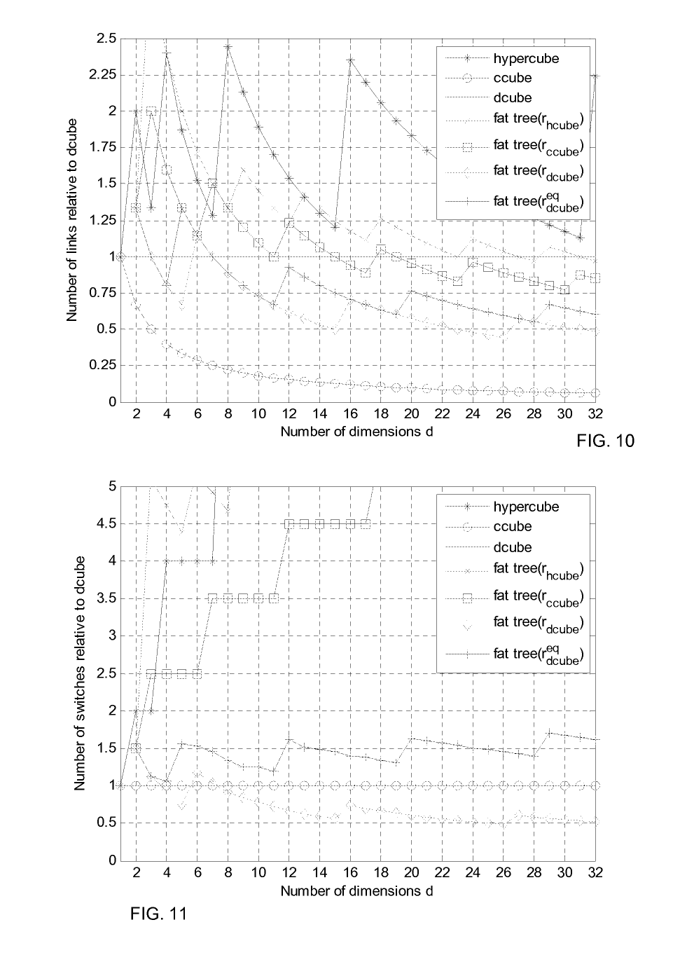

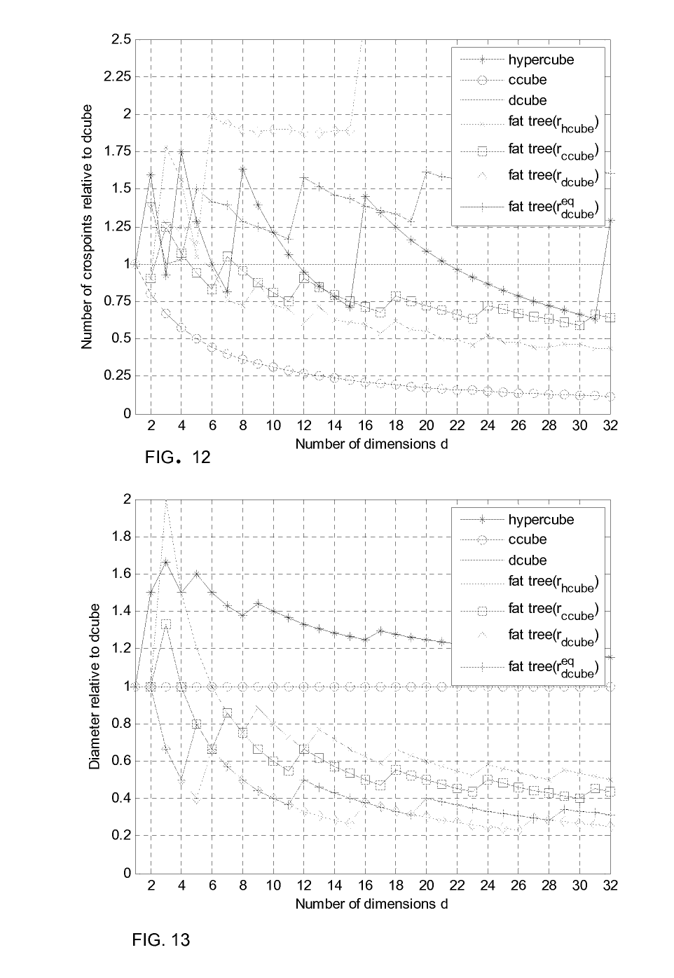

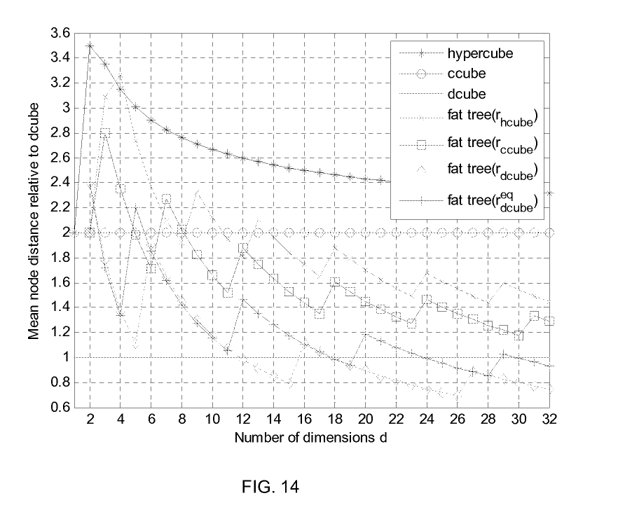

FIG. 10-14 provides characteristic comparisons between different network topologies and the generalization of the system of FIG. 5 and FIG. 6 to higher dimensions (which is referred to as “dcube” on the figures). More specifically, each of FIG. 10-14 provides the value of a ratio X/Y in function of the number of dimensions d, wherein X is respectively:
the number of links (FIG. 10),
the number of routing nodes or switches (FIG. 11),
the number of crosspoints implemented (FIG. 12),
the diameter of the network (FIG. 13), and
the mean node distance(FIG. 14)
   for different topologies, whereas Y is the same value as X for the generalization of the system of FIG. 5 and FIG. 6.

All in all, the generalization of the system of FIG. 5 and FIG. 6 provide characteristics which provide a ratio performance versus costs which is particularly satisfying for parallel computing.

In another aspect, it is proposed computer program comprising instructions for causing a routing node belonging to a system described above to participate to performing the above method. The routing node may thus have stored on a memory thereof such a program. Such a program may be used in conjunction with a computer program comprising instructions for causing a computing node belonging to a system described above to participate to performing the method. The program may be stored on a memory of the computing node. Alternatively, only the program for the computing node may be sufficient for performing the method.

For example, if the method is used for parallel processing, the program for the computing node may include instructions to send to the routing node to which the computing node is connected the information appropriately to the phase of the method, including its identifier and the identifier of the destination computing node. Optionally, the path may also be sent to the routing node, such that the routing node does not need a particular program. Alternatively, the conflict management may be performed by a program at the routing node level.

As will be appreciated by one skilled in the art, aspects of the present invention may be embodied as a system, method or computer program products. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention that take the form of a computer program product may be embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. The computer program instructions may be loaded onto a computing node or onto a routing node, according to the kind of program.

Computer program code for carrying out operations for aspects of the present invention may be written in any combination of one or more programming languages, including an object oriented programming language such as Java, Smalltalk, C++or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The above explanations refer to examples of the invention which may be easily modified by the person skilled in the art. For example, the system has been described with reference to hypercubes and concentrated hypercube networks, but it is not necessary that the routing form exactly a hypercube to benefit from the ideas brought by the invention. In particular, some vertices and/or some edges of the hypercube may be missing, for instance because routers and/or communication links are disabled.

1. A computer system comprising:
a plurality of routing nodes,
a plurality of computing nodes with processing devices,
first communication links, wherein the first communication links connect pairs consisting of two routing nodes together, the routing nodes and the first communication links forming a hypercube structure,
second communication links, wherein the second communication links connect pairs consisting of a routing node and a computing node together, and
third communication links, wherein the third communication links connect pairs consisting of two routing nodes together.

2. The system of claim 1, wherein the routing nodes, the computing nodes, the first communication links and the second communication links form a concentrated hypercube network.

3. The system of claim 2, wherein the number of computing nodes connected to a routing node is equal to the dimension of the hypercube structure.

4. The system of claim 1, wherein the third communication links connect pairs consisting of two routing nodes which are not connected by a first communication link.

5. The system of claim 4, wherein the third communication links correspond to diagonals of the hypercube structure.

6. The system of claim 5, wherein each of the third communication links corresponds to a respective one of the diagonals, the number of third communication links being the same as the number of diagonals.

7. The system of claim 1, wherein within at least one routing node, at least some crosspoints are not implemented.

8. The system of claim 7, wherein the at least some crosspoints which are not implemented comprise at least one of:
from one third communication link to another third communication link,
from a second communication link to a third communication link, and
from a third communication link to a first communication link.

9. A method for circulating information over a computer system comprising a plurality of routing nodes, a plurality of computing nodes with processing devices, first communication links, wherein the first communication links connect pairs consisting of two routing nodes together, the routing nodes and the first communication links forming a hypercube structure, second communication links, wherein the second communication links connect pairs consisting of a routing node and a computing node together, and third communication links, wherein the third communication links connect pairs consisting of two routing nodes together, the method comprising:
transmitting information between at least one first computing node and at least one second computing node, via at least one third communication link.

10. The method of claim 9 wherein the at least one first computing node is connected to a first routing node, and the at least one second computing node is connected to a second routing node, the first and second routing nodes are connected together, and the transmitting of the information is via at least one first communication link, the at least one first communication link and the at least one third communication link connecting the first and second routing nodes to at least one third routing node, wherein the method further comprises:
while transmitting the information, further transmitting other information between a third computing node connected to the first routing node and a fourth computing node connected to the second routing node via a first communication link connecting the first and second routing nodes together.

11. The method of claim 10, wherein the at least one first computing node consists of all the computing nodes connected to the first routing node distinct from the third computing node, and the at least one second computing node consists of all the computing nodes connected to the second routing node distinct from the fourth computing node.

12. The method of claim 11, wherein the transmitting of the information and the transmitting of the other information are iterated over all pairs of routing nodes of the system which are connected together.

13. A computer program storage medium storing instructions for causing a routing node to perform a method for circulating information over a computer system comprising a plurality of routing nodes, a plurality of computing nodes with processing devices, first communication links, wherein the first communication links connect pairs consisting of two routing nodes together, the routing nodes and the first communication links forming a hypercube structure, second communication links, wherein the second communication links connect pairs consisting of a routing node and a computing node together, and third communication links, wherein the third communication links connect pairs consisting of two routing nodes together, the method comprising:
transmitting information between at least one first computing node and at least one second computing node, via at least one third communication link.

14. A computer program storage medium storing instructions for causing a computing node to perform a method for circulating information over a computer system comprising a plurality of routing nodes, a plurality of computing nodes with processing devices, first communication links, wherein the first communication links connect pairs consisting of two routing nodes together, the routing nodes and the first communication links forming a hypercube structure, second communication links, wherein the second communication links connect pairs consisting of a routing node and a computing node together, and third communication links, wherein the third communication links connect pairs consisting of two routing nodes together, the method comprising:
transmitting information between at least one first computing node and at least one second computing node, via at least one third communication link.
